(19) United States
(12) Patent Application Publication
(10) Pub. No.: US 2008/0299525 A1
(43) Pub. Date: Dec. 4, 2008

(54) Operation training system and operation training method

(75) Inventor: Takeshi Murakami, Musashino-shi (JP)

Correspondence Address: Edwards Angell Palmer & Dodge LLP, P.O. Box 55874, Boston, MA, 02205, US

(73) Assignee: Yokogawa Electric Corporation, Tokyo (JP)

(21) Appl. No.: 12/156,406

(22) Filed: May 29, 2008

(30) Foreign Application Priority Data
May 31, 2007 (JP) 2007-144949

(51) Int. Cl. G09B 19/00

(52) U.S. Cl. 434/219

(57) ABSTRACT

A safety station simulator is implemented using an application program and a communication program installed in a personal computer. The application program is a program actually used with a safety station of a real machine. Since the program used with the real machine can be used intact, it is not necessary to again describe the application for an operation training system.

This application claims priority to Japanese Patent Application No. 2007-144949, filed May 31, 2007, in the Japanese Patent Office. The Japanese Patent Application No. 2007-144949 is incorporated by reference in its entirety.

### TECHNICAL FIELD

The present disclosure relates to an operation training system for training an operator in operation of a safety instrumentation system connected to a plant control system.

### RELATED ART

A plant control system having a function of simulating the system containing an operation monitor station with software in a computer to train the operator in operation of the plant control system is known. Such a function and a process simulator for simulating the dynamic characteristics of a process are used in combination, whereby it is made possible to simulate the whole plant in a computer and operation training for plant operation can be performed.

[Patent document 1] Japanese Patent Application Publication No. 2005-78545

On the other hand, in the plant control system, integration of various systems and functions is proceeding and a system also exists wherein a safety instrumentation system is connected to a plant control system and operation monitor of the safety instrumentation system can be performed through an operation monitor station of the plant control system.

However, an operation training system for conducting operation training meeting such a system mentioned above is not developed; training on a risk averting procedure by manual operation of a safety instrumentation system at emergency occurrence time, training on a recovery procedure after automatic emergency shutdown by a safety instrumentation system, training on a plant start-up procedure including opening of an emergency shutdown valve, etc., controlled from a safety instrumentation system, or the like cannot be conducted.

To conduct operation training containing a safety instrumentation system using the operation training system in the related art, it becomes necessary to again describe the application logic executed in the safety instrumentation system in a description language used in a control station of the plant control system and substitute operation by a simulator of the plant control system. However, the safety instrumentation system and the plant control system differ in application description language, identifiers of field instruments and signal lines, etc., and conversion of the application description requires a large number of man-hours.

### SUMMARY

Exemplary embodiments of the present invention provide an operation training system and an operation training method capable of training an operator in operation of a safety instrumentation system connected to a plant control system with easy system construction.

An operation training system of the invention is an operation training system for training an operator in an operation of a safety instrumentation system connected to a plant control system. The operation training system includes a simulator for executing simulation of a process controlled by the plant control system; an operation acceptance section for accepting the operation; a first program execution section for executing an installed program used with the safety instrumentation system in accordance with the operation on the operation acceptance section; and a first communication section for executing communications between the first program execution section and the simulator, thereby reflecting the execution result of the installed program on the simulation in the simulator.

According to the operation training system, the installed program used with the safety instrumentation system is executed and the execution result of the installed program is reflected on the simulation, so that the operator can be trained in operating the safety instrumentation system connected to the plant control system and the system can be easily constructed.

The operation training system may further include a second program execution section for executing an installed program used with the plant control system and a second communication section for executing communications between the second program execution section and the simulator, thereby reflecting the execution result of the installed program from the second program execution section on the simulation in the simulator.

The simulator may execute simulation of panel instrumentation in combination with the simulation of the process.

An operation training method of the invention is an operation training method for training an operator in an operation of a safety instrumentation system connected to a plant control system. The operation training method including the steps of executing simulation of a process controlled by the plant control system by a simulator; accepting the operation; executing an installed program used with the safety instrumentation system in accordance with the operation accepted in the step of accepting the operation; and executing communications between the installed program and the simulator, thereby reflecting the execution result of the installed program on the simulation of the simulator.

According to the operation training method, the installed program used with the safety instrumentation system is executed and the execution result of the installed program is reflected on the simulation, so that the operator can be trained in operating the safety instrumentation system connected to the plant control system and the system can be easily constructed.

According to the operation training system of the invention, the installed program used with the safety instrumentation system is executed and the execution result of the installed program is reflected on the simulation, so that the operator can be trained in operating the safety instrumentation system connected to the plant control system and the system can be easily constructed.

According to the operation training method of the invention, the installed program used with the safety instrumentation system is executed and the execution result of the installed program is reflected on the simulation, so that the operator can be trained in operating the safety instrumentation system connected to the plant control system and the system can be easily constructed.

Other features and advantages may be apparent from the following detailed description, the accompanying drawings and the claims.

### BRIEF DESCRIPTION OF THE DRAWINGS

In the accompanying drawings:

FIG. 1A is a block diagram to show a configuration example of a plant control system to which a safety instrumentation system is connected.

FIG. 1B is a block diagram to show the configuration of an operation training system of the embodiment of the invention constructed meeting the plant control system in FIG. 1A;

FIG. 2 is a block diagram to show details of the operation training system of the embodiment of the invention;

FIG. 3A is a block diagram to show a configuration example of a plant control system to which panel instrumentation is connected; and

FIG. 3B is a block diagram to show the configuration of an operation training system constructed meeting the plant control system in FIG. 3A.

### DETAILED DESCRIPTION

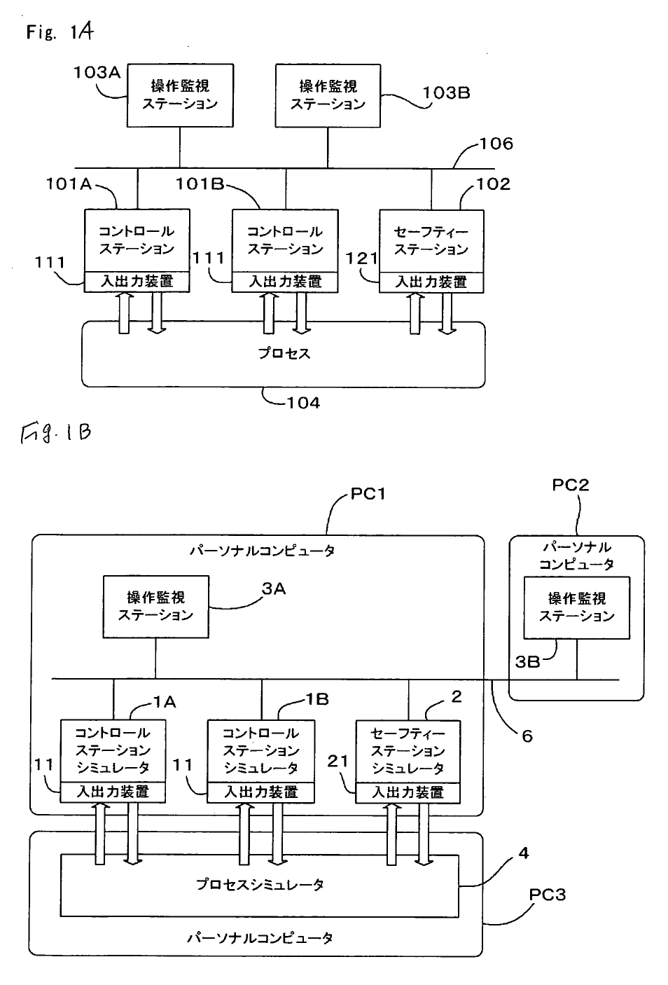

Embodiments of an operation training system according to the invention will be discussed with reference to FIGS. 1A to 3B.

FIG. 1A is a block diagram to show a configuration example of a plant control system to which a safety instrumentation system is connected, and FIG. 1B is a block diagram to show the configuration of the operation training system of the embodiment of the invention constructed meeting the plant control system in FIG. 1A.

The plant control system shown in FIG. 1A includes control stations 101A and 101B distributed in a plant for controlling a process 104 through a field instrument group, a safety station 102 for executing control to secure safety of the plant such as emergency shutdown of the field instruments, and operation monitor stations 103A and 103B for accepting various operations of the operator and operating and monitoring the field instrument group through the control stations 101A and 101B and the safety station 102.

As shown in FIG. 1A, the control stations 101A and 101B, the safety station 102, and the operation monitor stations 103A and 103B are connected to each other through a control bus 106.

The control stations 101A and 101B are connected through input/output units 111 to the field instrument group, and the safety station 102 is connected through an input/output unit 121 to the field instrument group.

On the other hand, as shown in FIG. 1B, the operation training system of the embodiment is implemented using three personal computers PC1, PC2, and PC3 connected according to TCP/IP.

As shown in FIG. 1B, the personal computer PC1 implements control station simulators 1A and 1B, for simulating the control stations 101A and 101B, a safety station simulator 2 for simulating the safety station 102, and an operation monitor station 3A as operation acceptance section for simulating the operation monitor station 103A. The personal computer PC2 implements an operation monitor station 3B as operation acceptance section for simulating the operation monitor station 103B. Further, the personal computer PC3 implements a process simulator 4 as simulator for simulating the process 104.

The control station simulators 1A and 1B, the safety station simulator 2, and the operation monitor stations 3A and 3B are connected to each other through a virtual control bus 6 provided across the personal computers PC1 and PC2. Accordingly, the operator can operate and monitor the control station simulators 1A and 1B and the safety station simulator 2 from the operation monitor station 3B like the operation monitor station 3A.

The control station simulators 1A and 1B are connected through virtual input/output units 11 to a field instrument group of the process simulator 4, and the safety station simulator 2 is connected through a virtual input/output unit 21 to the field instrument group of the process simulator 4.

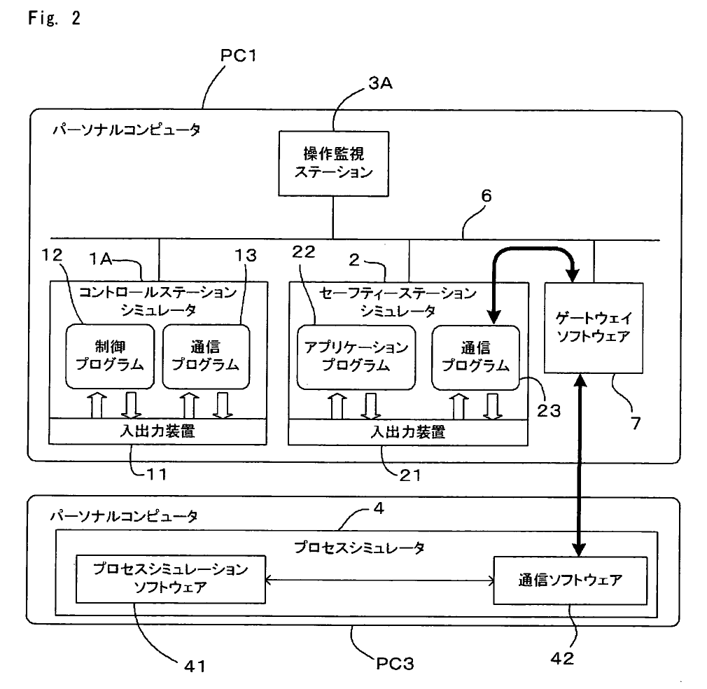

FIG. 2 is a block diagram to show details of the operation training system of the embodiment of the invention.

As shown in FIG. 2, the control station simulator 1A is implemented using a control program 12 as second program execution section and a communication program 13 as second communication section installed in the personal computer PC1. The control station simulator 1B is also implemented like the control station simulator 1A.

The control program 12 is an installed program actually used with the control station 101A of a real machine. Since the program used with the real machine can be used intact, it is not necessary to again describe the application for the operation training system.

The communication program 13 is a program for executing communications with the process simulator 4 through gateway software 7 installed in the personal computer PC1. The function of the program is further described later.

As shown in FIG. 2, the safety station simulator 2 is implemented using an application program 22 as first program execution section and a communication program 23 as first communication section installed in the personal computer PC1.

The application program 22 is an installed program actually used with the safety station 102 of a real machine. Since the program used with the real machine can be used intact, it is not necessary to again describe the application for the operation training system.

The communication program 23 is a program for executing communications with the process simulator 4 through the gateway software 7 installed in the personal computer PC1. The function of the program is further described later.

As shown in FIG. 2, the process simulator 4 is implemented using process simulation software 41 and communication software 42.

The process simulation software 41 has a process value used with the process 104 as a variable and executes calculation using the processing value, thereby simulating the dynamic characteristics of the process 104.

On the other hand, the communication software 42 retains the relationship between each variable used with the process simulation software 41 and input/output terminals of the input/output units 11 of the control station simulators 1A and 1B, and sends a request for writing the calculation result of the process simulation software 41 to the input/output terminal of the corresponding input/output unit 11 to the gateway software 7 according to a dedicated protocol. In contrast, the communication software 42 acquires a simulated output signal from the input/output terminal of the input/output unit 11 through the gateway software 7 and sends the signal to the process simulation software 41.

To conduct communications between the process simulator 4 and the control station simulator 1A, 1B, the gateway software 7 executes protocol conversion between the dedicated protocol used for communications with the process simulation software 41 and the protocol used with the virtual control bus 6.

The communication program 13 of each of the control station simulators 1A and 1B mediates a simulated input/output signal of the input/output unit 11 exchanged between the control program 12 and the process simulator 4. The communication program 13 writes an input signal sent from the process simulator 4 into a predetermined input/output terminal of the input/output unit 11. The written value is used in computation of the control program 12 and the computation result is also written into a predetermined input/output terminal of the input/output unit 11. The output value written by the control program 12 is sent by the communication program 13 through the gateway software 7 to the process simulator 4.

The communication software 42 retains the relationship between each variable used with the process simulation software 41 and an input/output terminal of the input/output unit 21 of the safety station simulator 2, and sends a request for writing the calculation result of the process simulation software 41 to the input/output terminal of the input/output unit 21 to the gateway software 7 according to the dedicated protocol. In contrast, the communication software 42 acquires a simulated output signal from the input/output terminal of the input/output unit 21 through the gateway software 7 and sends the signal to the process simulation software 41.

To conduct communications between the process simulator 4 and the safety station simulator 2, the gateway software 7 executes protocol conversion between the dedicated protocol used for communications with the process simulation software 41 and the protocol used with the virtual control bus 6.

The communication program 23 of the safety station simulator 2 mediates a simulated input/output signal of the input/output unit 21 exchanged between the application program 22 and the process simulator 4. The communication program 23 writes an input signal sent from the process simulator 4 into a predetermined input/output terminal of the input/output unit 21. The written value is used in computation of the application program 22 and the computation result is also written into a predetermined input/output terminal of the input/output unit 21. The output value written by the application program 22 is sent by the communication program 23 through the gateway software 7 to the process simulator 4 and is reflected on simulation of the process simulator 4.

Thus, in the operation training system of the embodiment, transfer of a simulated input/output signal between the safety station simulator 2 and the process simulator 4 is executed according to a similar mechanism to transfer of a simulated input/output signal between the control station simulator 1A, 1B and the process simulator 4. However, the control station 101A, 101B and the safety station 102 differ in application program description language and also differ in read of the input/output terminal of the input/output unit such as the identifiers of signal lines, etc. In the embodiment, such differences are absorbed in the communication programs 13 and 23, so that it is made possible to transfer a simulated input/output signal according to a similar mechanism while using the control program 12 and the application program 22 used in the actual machines as they are.

As described above, in the operation training system of the embodiment, the whole of the plant control system to which the safety instrumentation system is connected can be simulated. Thus, the operator can be trained in the whole plant operation into which the safety instrumentation system and the plant control system are integrated including the case where an emergency shutdown mechanism executed by the safety instrumentation system works, a procedure of resetting the emergency shutdown mechanism, etc.

Since the application program used with the safety instrumentation system of the real machine can be used intact, a training system closer to the actual plant can be easily constructed.

Since computers can also be used in combination, it is also possible to operate a large number of safety station simulators at the same time. Thus, the operation training system can also support training of a large-scaled plant.

Further, the application program used with the safety instrumentation system of the real machine can be used intact, so that the operation training system of the embodiment can also be used as a system to aid in creating an application program.

In the operation training system according to the invention, simulation for performing operation and monitoring with panel instrumentation aside from the operation monitor station can also be executed in combination with simulation of the process.

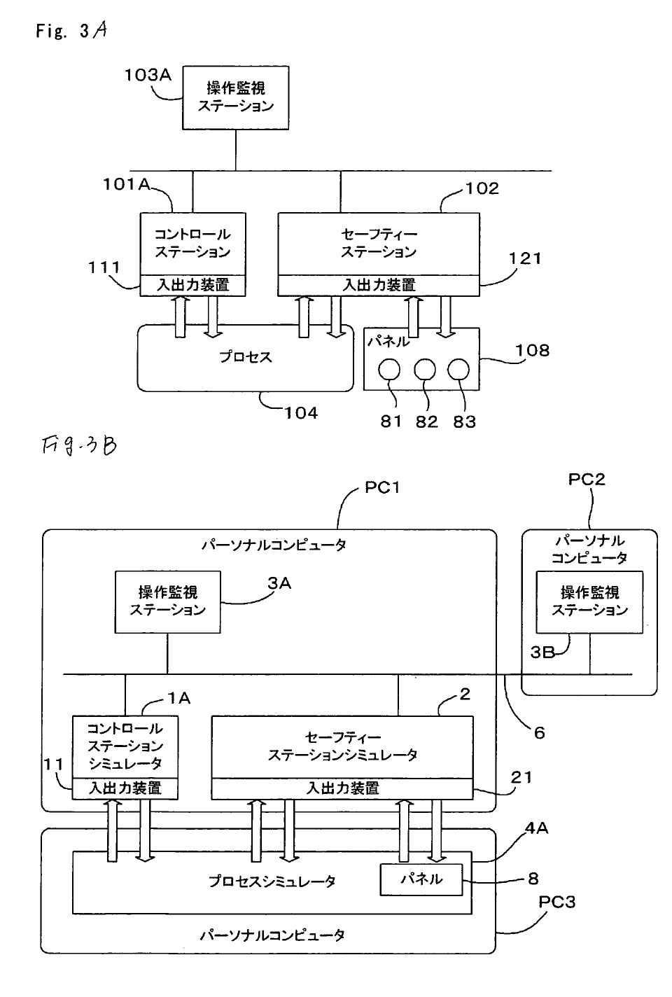

FIG. 3A is a block diagram to show a configuration example of a plant control system to which a panel instrumentation is connected, and FIG. 3B is a block diagram to show the configuration of an operation training system constructed meeting the plant control system in FIG. 3A. Components identical with those in FIG. 1 are denoted by the same reference numerals in FIG. 3 and will not be discussed again.

In the example shown in FIG. 3A, a panel 108 provided with a lamp 81, a siren 82, and a switch button 83 for manually operating an alarm, an instrument, etc., is installed in a plant. The lamp 81, the siren 82, the switch button 83, etc., is connected to a safety station 102 through an input/output unit 121.

As shown in FIG. 3B, the panel 108 of a real machine is simulated as a panel 8 in a process simulator 4A implemented as a personal computer PC3. The panel 8 is connected to a safety station simulator 2 for simulating the safety station 102 through a virtual input/output unit 21 like other field instruments. The panel 8 is displayed on a screen of the personal computer PC3, etc., and operation is accepted on the screen, whereby operation training on the panel is also made possible. At the training time, the operator performs process operation and monitoring through an operation monitor station 3A, 3B and can also be trained in operating and monitoring a safety instrumentation system through the panel 8 displayed on the screen.

As described above, according to the operation training system of the invention, the installed program used with the safety instrumentation system is executed and the execution result of the installed program can be reflected on simulation, so that the operator can be trained in operating the safety instrumentation system connected to the plant control system and work of again describing the application becomes unnecessary and the system can be easily constructed.

It is to be understood that the invention is not limited to the specific embodiments described above. The invention can be widely applied to an operation training system and an operation training method for training the operator in operation of a safety instrumentation system connected to a plant control system.

What is claimed is:

1. An operation training system for training an operator in an operation of a safety instrumentation system connected to a plant control system, said operation training system comprising:
a simulator for executing simulation of a process controlled by the plant control system;
an operation acceptance section for accepting the operation;
a first program execution section for executing an installed program used with the safety instrumentation system in accordance with the operation on said operation acceptance section; and
a first communication section for executing communications between said first program execution section and said simulator, thereby reflecting the execution result of the installed program on the simulation in said simulator.

2. The operation training system as claimed in claim 1 further comprising:
a second program execution section for executing an installed program used with the plant control system; and
a second communication section for executing communications between the second program execution section and said simulator, thereby reflecting the execution result of the installed program from the second program execution section on the simulation in said simulator.

3. The operation training system as claimed in claim 1 wherein said simulator executes simulation of a panel instrumentation in combination with the simulation of the process.

4. The operation training system as claimed in claim 2 wherein said simulator executes simulation of a panel instrumentation in combination with the simulation of the process.

5. An operation training method for training an operator in an operation of a safety instrumentation system connected to a plant control system, said operation training method comprising the steps of:
executing simulation of a process controlled by the plant control system by a simulator;
accepting the operation;
executing an installed program used with the safety instrumentation system in accordance with the operation accepted in said step of accepting the operation; and
executing communications between the installed program and the simulator, thereby reflecting the execution result of the installed program on the simulation of the simulator.
